(19) United States
(12) Patent Application Publication
(10) Pub. No.: US 2025/0143345 A1
(43) Pub. Date: May 8, 2025

(54) CREAMY PRODUCT, PIPING TOOL, AND METHOD FOR PRODUCING CREAMY PRODUCT

(71) Applicant: EPOCH COMPANY, LTD., Tokyo (JP)

(72) Inventor: Ryo SAKAI, Toyota (JP)

(73) Assignee: EPOCH COMPANY, LTD., Tokyo (JP)

(21) Appl. No.: 18/934,586

(22) Filed: Nov. 1, 2024

(30) Foreign Application Priority Data
Nov. 2, 2023 (JP) 2023-188188

(51) Int. Cl. A23G 3/34; A23G 3/28; A63H 33/30

(52) U.S. Cl. CPC A23G 3/343; A23G 3/28; A63H 33/30

(57) ABSTRACT

A creamy product having a high visual effect for decorating a toy, a piping tool for a creamy product, and a method for producing a creamy product are provided. A creamy product to be discharged using a piping tool to prepare a decorative body toy, the creamy product includes a transparent resin containing starch and one or both of a glitter and a decorative chip body.

### CROSS-REFERENCE TO RELATED APPLICATIONS

This application claims priority from Japanese Patent Application No. 2023-188188 filed on Nov. 2, 2023. The entire content of the priority application is incorporated herein by reference.

### TECHNICAL FIELD

The present disclosure relates to a creamy product, a piping tool, and a method for producing a creamy product.

### BACKGROUND ART

Toys that use tubes filled with a creamy resin to prepare simulated foods such as cakes have been proposed. For example, Patent Literature 1 discloses a creamy product discharged from a piping tool to create a decorative body toy. The creamy product is a creamy resin, contains starch, and is transparent.

### CITATION LIST

### Patent Literature

Patent Literature 1: JP2021-170485A

### SUMMARY OF INVENTION

However, the creamy product in Patent Literature 1 is semi-transparent to such an extent that a decorative body support portion on which the creamy product is to be served can be visually recognized. That is, the translucency was not high, and the type of the creamy product was mainly expressed by the color. Therefore, the optical visual effect of the creamy product was poor.

An object of the present disclosure is to provide a creamy product having a high visual effect for decorating a toy, a piping tool for a creamy product, and a method for producing a creamy product.

A creamy product to be discharged using a piping tool to prepare a decorative body toy, according to the present disclosure includes a transparent resin comprising starch and one or both of a glitter and a decorative chip body.

A piping tool according to the present disclosure includes a creamy product for preparing a decorative body toy, including a transparent resin containing starch, and one or both of a glitter and a decorative chip body, a container having translucency and flexibility for containing the creamy product, and a nozzle connected to one end of the container. The container is sealed on an opposite side to the nozzle and contains the creamy product.

A method for producing a creamy product to be discharged using a piping tool to prepare a decorative body toy, according to the present disclosure includes supplying, to the container, one or both of a glitter and a decorative chip body and supplying a transparent resin containing starch to the container to which one or both of the glitter and the decorative chip body are supplied. The piping tool includes a container having translucency and flexibility for containing the creamy product, and a nozzle connected to one end of the container.

The present disclosure allows for providing a creamy product having a high visual effect for decorating a toy, a piping tool for a creamy product, and a method for producing a creamy product.

### BRIEF DESCRIPTION OF DRAWINGS

FIG. 1 is a front view of a piping tool for discharging a creamy product.

FIG. 2 is a perspective view of a heart-shaped decorative chip body and a star-shaped decorative chip body.

FIG. 3 is a perspective view of a shell-shaped decorative chip body and a candy-shaped decorative chip body.

FIG. 4 is a perspective view of a decorative chip body that imitates the body of an animal and a decorative chip body that imitates the face of an animal.

FIG. 5 is a perspective view of a decorative chip body that imitates the hand of an animal.

FIG. 6 is a flowchart of producing a creamy product.

FIG. 7 is a perspective view showing a state in which the creamy product is discharged onto a white flat surface.

FIG. 8 is a perspective view showing a state in which the creamy product is discharged onto a black flat surface.

FIG. 9 is a perspective view illustrating a state in which the creamy product is discharged onto a decorative body toy.

### DESCRIPTION OF EMBODIMENTS

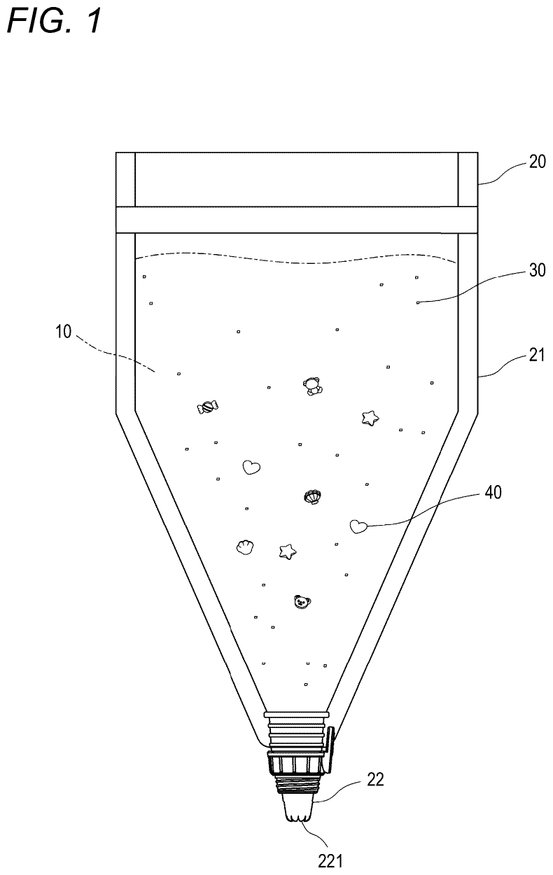

Hereinafter, an embodiment of the present disclosure will be described with reference to the drawings. FIG. 1 is a front view of a piping tool 20. The piping tool 20 includes a container 21 that has the translucency and the flexibility and that contains a creamy product 10, and a nozzle 22 that is connected to one end of the container 21. The container 21 is formed by stacking two sheet members that have the flexibility and that are made of a polyvinyl chloride resin for example and welding the sides thereof by thermocompression. The rear end portion of the container 21 that is opposite to the nozzle 22 is sealed with the creamy product 10 contained therein by overlapping two sheet members and welding the two sheet members together by thermocompression. As the welding method, other methods such as ultrasonic welding may also be applied.

The creamy product 10 is discharged using the piping tool 20 in order to prepare a decorative body toy. The decorative body toy can be prepared by discharging the creamy product 10 through a discharge port 221 at the tip of the piping tool 20 and putting the creamy product 10 on a surface for preparation of a decorative body that simulates a food such as a cake.

The creamy product 10 is prepared by adding a preservative or the like to a synthetic resin such as an acrylic resin and is solidified when exposed to air and dried. The creamy product 10 is a creamy resin that can be colored in various colors such as light blue, pink, and white using a coloring agent (for example, a coloring agent serving as a food additive). The resin used in the creamy product 10 according to the present embodiment is, for example, a polyacrylic acid emulsion containing acrylic acid, a surfactant, water, and the like.

The creamy product 10 according to the present embodiment contains starch, preferably potato starch. The creamy product 10 has a small amount (2.00 parts by weight to 2.20 parts by weight in the present embodiment) of starch. Therefore, the creamy product 10 according to the present embodiment is formed transparently without impairing the translucency. The term “transparent” in the present embodiment refers to an optical property of translucency that allows the shape of a portion covered with the creamy product 10 and a portion placed nearby on the opposite side across the creamy product 10 to be easily or clearly recognized and does not include so-called semi-transparent. Accordingly, the creamy product 10 may be colorless with no added coloring agent, or when the creamy product 10 is colored, a small amount of coloring agent (for example, food coloring) may be added to the extent that the creamy product 10 is recognized as transparent and not cloudy.

The creamy product 10 includes one or both of a glitter 30 and a decorative chip body 40. As shown in FIG. 1, the creamy product 10 according to the present embodiment includes both the glitter 30 and the decorative chip body 40. The creamy product 10 according to the present embodiment contains 96.47 parts by weight of a polyacrylic acid emulsion and 2.09 parts by weight of starch and contains approximately 1.39 parts by weight of the glitter 30 and the decorative chip body 40 in total. The creamy product 10 may include a small amount of phenoxyethanol as a preservative and an optional coloring agent as other ingredients. When the colorless and transparent creamy product 10 is produced, the coloring agent may not be contained.

The glitter 30 is, for example, a metal foil such as aluminum or a resin piece provided with a reflective layer such as aluminum. The glitter 30 may be a small piece (for example, a polygon such as a square shape and a triangular shape, or a circular shape) whose shape is visible, or may be a small piece or a fine powder whose shape cannot be visually recognized. Even if the glitter 30 is so small that the shape of the glitter cannot be visually recognized, the creamy product 10 can give the viewer a sense of gloss due to the reflected light from the dispersed glitter 30. A coloring agent (for example, food coloring) may be applied to the surface of the glitter 30 as desired.

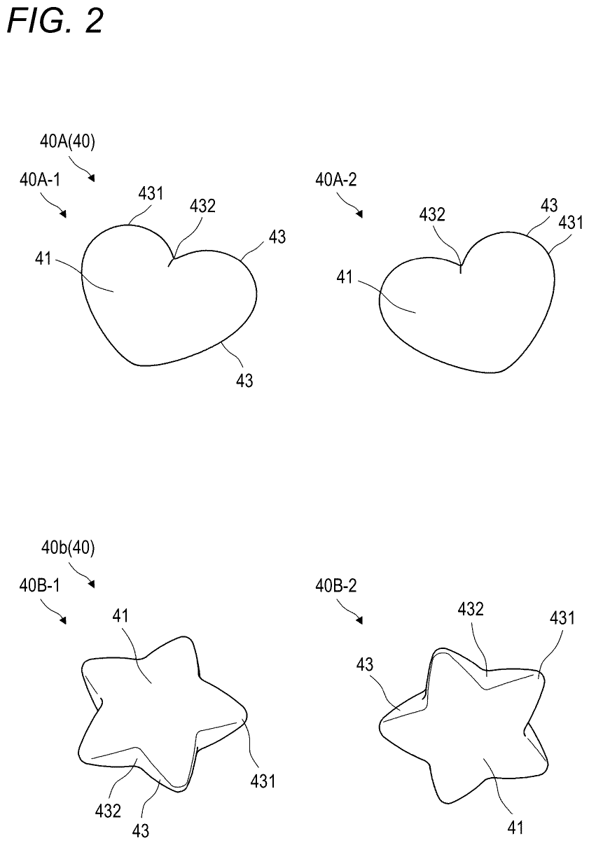

FIGS. 2 to 5 show seven types of the decorative chip bodies 40A to 40G as examples of the decorative chip body 40. The decorative chip body 40 according to the present embodiment is opaque and colored (for example, yellow-green), and the transparency and the color can be adjusted as desired. The decorative chip body 40 may be subjected to applying a fluorescent paint to the surface of the decorative chip body 40 or may contain the fluorescent paint as a part of the material of the decorative chip body 40. The surface of the decorative chip body 40 may diffusely reflect light or may specularly reflect light. The decorative chip bodies 40A to 40G are formed to be smaller than the opening diameter of the nozzle 22 of the piping tool 20 and larger than the glitter 30. The decorative chip bodies 40A to 40G have a flat three-dimensional shape having one or both of a curved surface 41 and a flat surface 42 and have a convex portion 431 on a side peripheral surface 43. The decorative chip bodies 40A to 40G have a recess 432 in the side peripheral surface 43.

The heart-shaped decorative chip body 40A in FIG. 2 is shown in a planar perspective view (a decorative chip body 40A-1) and a bottom perspective view (a decorative chip body 40A-2). The decorative chip body 40A has a left-right symmetrical shape and an upper-lower symmetrical shape and has the curved surface 41 that is convexly curved on the flat surface and the bottom surface. The decorative chip body 40A has the convex portion 431 on the side peripheral surface 43 and is connected by the recess 432 formed at one location of the side peripheral surface 43. That is, the decorative chip body 40A has a heart shape in the plan view.

The star-shaped decorative chip body 40B in FIG. 2 is shown in a planar perspective view (a decorative chip body 40B-1) and a bottom perspective view (a decorative chip body 40B-2). The decorative chip body 40B has a left-right symmetrical shape and an upper-lower symmetrical shape and has the curved surface 41 that is convexly curved on the flat surface and the bottom surface. The decorative chip body 40B alternately has on the side peripheral surface 43, the convex portion 431 that has an acute angle in the plan view and the recess 432 that has an obtuse angle in the plan view. Five convex portions 431 and five recesses 432 are provided. The decorative chip body 40B is formed such that the upper and lower central axis sides are thick. Therefore, the periphery of the recess 432 is thicker than the periphery of the convex portion 431. In this way, the decorative chip body 40B is formed in a star shape in the plan view.

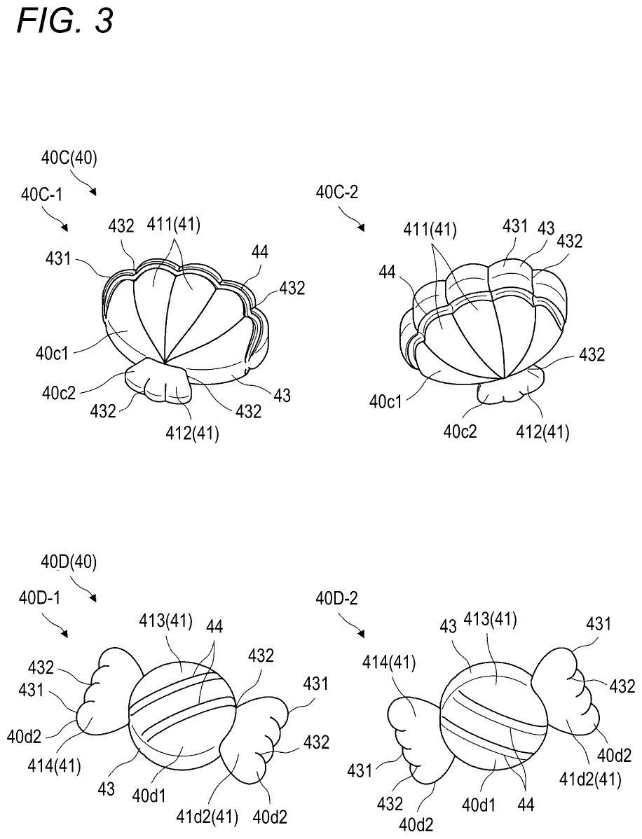

The shell-shaped decorative chip body 40C in FIG. 3 is shown in a planar perspective view (a decorative chip body 40C-1) and a bottom perspective view (a decorative chip body 40C-2). The decorative chip body 40C has a left-right symmetrical shape and an upper-lower symmetrical shape and has the curved surface 41 that is convexly curved on the flat surface and the bottom surface. The decorative chip body 40C includes a substantially fan-shaped main body portion 40c1 in the plan view, and a shell top portion 40c2 that protrudes from the side peripheral surface 43 on the opposite side to the arc-shaped side surface of the main body portion 40c1. A plurality of curved surfaces 41 of the main body portion 40c1 are formed on the flat surface and the bottom surface, and radial ribs are imitated on each surface. The shell top portion 40c2 is formed in a substantially fan shape that is smaller than the main body portion 40c1 in the plan view. Therefore, the decorative chip body 40C is formed such that the entire body has a substantially fan-shaped shell shape in the planar view.

The main body portion 40c1 has a recessed groove 44 (a recess) that is continuously formed in the left-right direction on the flat surface and the bottom surface. The recessed groove 44 is located on the arc-shaped end portion side (the opposite side to the shell top portion 40c2) 30 of the main body portion 40c1 and is approximately parallel to the side peripheral surface 43 in the plan view.

The candy-shaped decorative chip body 40D in FIG. 3 is shown in a planar perspective view (a decorative chip body 40D-1) and a bottom perspective view (a decorative chip body 40D-2). The entire shape of the decorative chip body 40D excluding the recessed groove 44 (the recess) is left-right symmetrical and upper-lower symmetrical. The decorative chip body 40D has the curved surface 41 that is convexly curved on the flat surface and the bottom surface. The decorative chip body 40D includes a central portion 40d1 that imitates a portion in which a candy is wrapped in the wrapping paper, and a wrapping paper end portion 40d2 that is located at both left and right ends of the central portion 40d1. The central portion 40d1 is formed in a thick and substantially circular plate shape. The decorative chip body 40D has a plurality of convex portions 431 and the recess 432 on the side peripheral surface 43. The recess 432 that is formed at the boundary between the central portion 40d1 and the end portion 40d2 is formed at an acute angle in the plan view. The recess 432 of the end portion 40d2 is formed on both left and right side surfaces. Therefore, the decorative chip body 40D has the shape of an individually wrapped candy in the plan view.

The decorative chip body 40D has two recessed grooves 44 (recesses) on the flat surface and the bottom surface of the central portion 40d1. The two recessed grooves 44 are arranged in parallel in the oblique direction in the plan view and the bottom view.

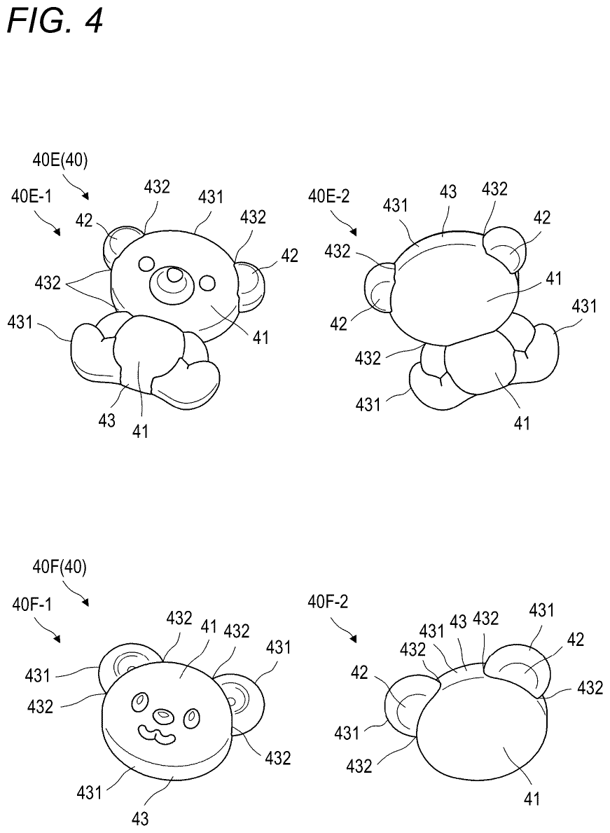

The decorative chip body 40E that imitates the body of the animal in FIG. 4 is shown in a planar perspective view (a decorative chip body 40E-1) and a bottom perspective view (a decorative chip body 40E-2). The decorative chip body 40E includes a head portion and a body portion. The decorative chip body 40E has a shape that imitates the front surface of the animal on the flat surface side and has a shape that imitates the back surface of the animal on the bottom surface side. The head portion, the body portion, the arm portion, and the leg portion of the decorative chip body 40E each include the curved surface 41 that is convexly curved toward the flat surface and the bottom surface. The head portion, the body portion, the arm portion, and the leg portion of the decorative chip body 40E include the convex portion 431 that is convexly curved even on the side peripheral surface 43. Further, the head portion, the body portion, the arm portion, and the leg portion of the decorative chip body 40E have the recess 432 at each boundary portion. The recess 432 is also continuously provided on the boundary portion between the curved surfaces 41 that are convexly curved on the flat surface side or the bottom surface side. The recess 432 is formed at an acute angle and an obtuse angle in the plan view or in the bottom view.

The decorative chip body 40F that imitates the face (the head portion) of the animal in FIG. 4 is shown in a planar perspective view (a decorative chip body 40F-1) and a bottom perspective view (a decorative chip body 40F-2). The decorative chip body 40F has a left-right symmetrical shape that imitates the front of the head portion of the animal on the flat surface side. The decorative chip body 40F has the curved surface 41 that is convexly curved on the flat surface and the bottom surface. The convexly curved surface 41 is provided in each of the head portion and the ear portion. The ear portion has the flat surface 42 on the bottom surface side. The decorative chip body 40F alternately has the convex portion 431 and the recess 432 on the side peripheral surface 43. The recess 432 of the side peripheral surface 43 is formed at the boundary portion between the head portion and the ear portion, and the other side peripheral surface is formed as the convex portion 431. In this way, the decorative chip body 40F is formed to be the face (the head portion) of the animal in the plan view.

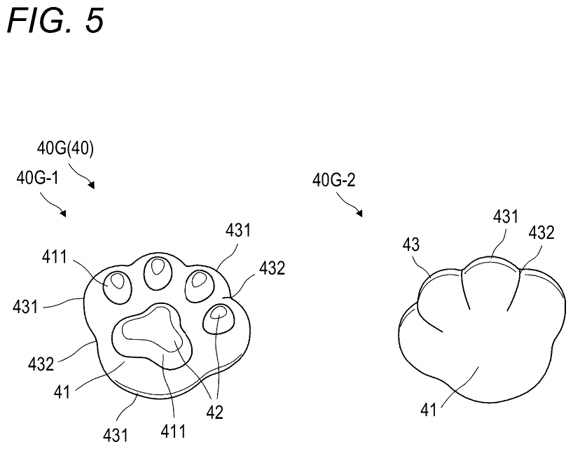

The decorative chip body 40G that imitates the hand of the animal in FIG. 5 is shown in a planar perspective view (a decorative chip body 40G-1) and a bottom perspective view (a decorative chip body 40G-2). The decorative chip body 40G has a left-right symmetrical shape that imitates the hand of the animal on the flat surface side. The decorative chip body 40G has a shape that imitates the palm of the animal on the flat surface side and has a shape that imitates the back of the hand of the animal on the bottom surface side. The decorative chip body 40G has the curved surface 41 that is convexly curved on the flat surface and the bottom surface. The curved surface 41 on the flat surface side is provided with a convex portion 411 that imitates a paw pad and that further protrudes on the flat surface side. The flat surface 42 is formed in the convex portion 411. The side peripheral surface 43 of the decorative chip body 40E has the convexly curved convex portion 431 and the recess 432.

Next, steps of a method for producing the creamy product 10 that is discharged using the piping tool 20 in order to prepare the decorative body toy will be described. Step S02 and step S03 may be performed automatically by the apparatus under control executed by a control unit of a computer or may be performed manually.

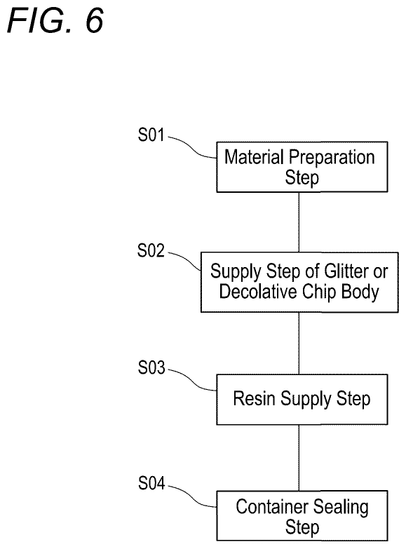

In step S01 in FIG. 6, the resin of the creamy product 10 is prepared in advance by mixing the above-described predetermined materials using any stirring device or stirring implement (also called a mixing device or mixing implement). In step S01, the glitter 30 and the decorative chip body 40 are prepared in advance.

In step S02, one or both of the glitter 30 and the decorative chip body 40 are supplied to the container 21. The glitter 30 and the decorative chip body 40 are supplied from the rear end portion of the container 21 on the opposite side to the nozzle 22.

In step S03, the above-described resin containing starch is supplied to the container 21 to which one or both of the glitter 30 and the decorative chip body 40 are supplied. In step S04, the rear end portion of the container 21 on the opposite side to the nozzle 22 is welded and sealed by thermocompression or the like.

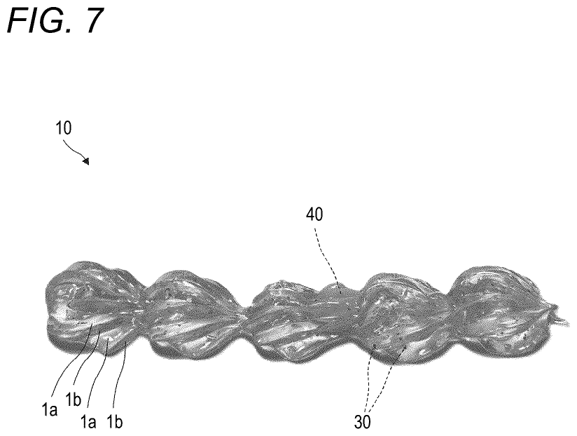

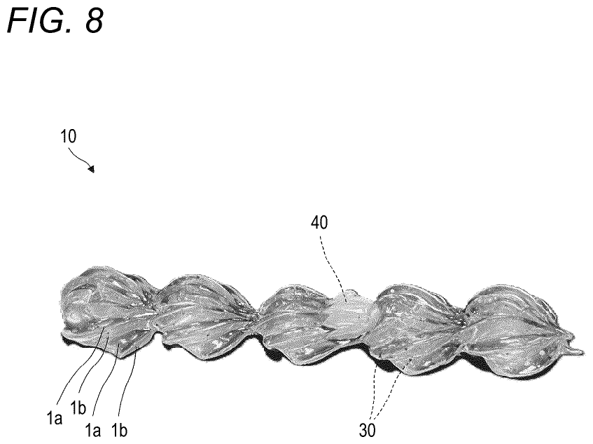

FIGS. 7 and 8 show the creamy product 10 according to the embodiment in the dried state. The creamy product 10 contains 96.47 parts by weight of a polyacrylic acid emulsion, 2.09 parts by weight of starch, 1.39 parts by weight of the glitter 30 and the decorative chip body 40 in total, phenoxyethanol, and a small amount of blue coloring agent. In this component configuration, the creamy product 10 is transparent and colored slightly in light blue and has a sharp peak suitable for the decorative purpose.

FIG. 7 is a perspective view showing a state in which the creamy product 10 is discharged from the piping tool 20 onto a white flat surface. The creamy product 10 contains the glitter 30 and the decorative chip body 40. The glitter 30 covered with the creamy product 10 is smaller than the pitch of the blade of the nozzle 22, and smaller than the pitch of the irregularities of the discharged creamy product 10. Thus, the position, the size, the shape, and the color of the glitter can be easily visually recognized. The glitter 30 in FIG. 7 is a substantially rectangular small piece. The decorative chip body 40 is smaller than the pitch of the blade of the nozzle 22, and thus, the shape of the decorative chip body is visually recognized as being refracted, but the position, the size, and the color can be easily visually recognized. It is also easily recognized that the flat surface on which the creamy product 10 is placed is white.

FIG. 8 is a perspective view showing a state in which the creamy product 10 is discharged from the piping tool 20 onto a black flat surface. The creamy product 10 contains the glitter 30 and the decorative chip body 40. The visibility of the glitter 30 and the decorative chip body 40 is approximately the same as that of the creamy product 10 in FIG. 7. It is also easily recognized that the flat surface on which the creamy product 10 is placed is black.

As described above, the creamy product 10 has such translucency that allows the shape of a portion covered with the creamy product 10 and a portion placed nearby on the opposite side across the creamy product 10 to be easily or clearly recognized. On the other hand, in the transparent creamy product 10, irregularities according to the shape of the nozzle 22 are formed. Accordingly, a region 1a through which background light is transmitted and is visually recognized, and a region 1b through which the background light is less likely to be visually recognized due to the angle of the surface or the like are formed. For example, in the creamy product 10 shown in FIGS. 7 and 8, in the region 1a, the color of a surface that the creamy product is placed is visually recognized, and in the region 1b, the reflected light of the external light or the like is easily visually recognized. Accordingly, in the region 1a and the region 1b, the color, the brightness, and the like are relatively different depending on the color of the surface that the creamy product is placed, and the change in the color according to the state of the placement surface can be enjoyed.

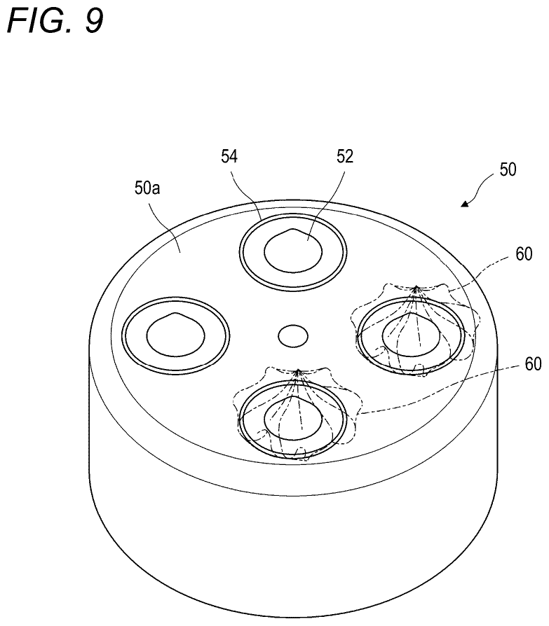

Next, an example will be described in which the creamy product 10 is discharged and put on a pedestal 50 of a decorative body toy as shown in FIG. 9. The pedestal 50 has a circular shape in the plan view, and is formed by, for example, injection molding using a resin material. An upper surface 50a of the pedestal 50 is a surface for preparation on which a decorative body 60 is prepared. The creamy product 10 that is discharged from the piping tool 20 in FIG. 1 can be put onto a decorative body support portion 52 on the preparation surface to form the decorative body 60, and this allows for preparing a decorative body toy that imitates a circular cake overall.

The decorative body support portions 52 are provided at four positions at equal intervals on the upper surface 50a of the pedestal 50. An annular convex portion 54 is provided on the upper surface of the outer periphery of the decorative body support portion 52. The annular convex portion 54 is formed in a circular shape in the plan view. When the creamy product 10 is put on the decorative body support portion 52 of the pedestal 50, the creamy product 10 is supported by the decorative body support portion 52 with a good appearance. The annular convex portion 54 is a guide for a position and a range in which the creamy product 10 is put. The annular convex portion 54 also functions as a guide to suppress spilling out of the creamy product 10 and to form a uniform and neat outer shape. When the creamy product 10 is put on all the decorative body support portions 32 and a predetermined time has elapsed, the creamy product 10 dries and solidifies to form the decorative body 60, and the decorative body toy can be completed.

The creamy product 10 according to the present embodiment is semi-transparent or has no translucency before solidification, and the user can easily recognize the position and the amount of the discharged creamy product 10 at the time of putting the creamy product 10. Therefore, as compared with the case of using a creamy product having high translucency before solidification, the decorative range of the creamy product 10 and the amount of the decorative body 60 can be easily recognized during the decorative operation, and thus, this achieves reducing the decorative failures. Therefore, a child can easily play with the creamy product 10 and enjoy the creamy product 10.

On the other hand, the solidified creamy product 10 is transparent. Accordingly, the completed decorative body 60 can be enjoyed by visually recognizing the contained glitter 30 or decorative chip body 40, and a change in the color depending on the state of the surface that the creamy product is placed can also be enjoyed.

The creamy product 10 contains starch (potato starch in the present embodiment) and is thus prepared to be soft by gelatinization of the starch. Thus, the creamy product 10 is easy to be discharged from the piping tool 20 and has excellent formability when the creamy product 10 is put on an object to be decorated. The creamy product 10 contains the potato starch, and thus, the creamy product 10 dries and solidifies, and the decorative body 60 (see FIG. 9) hardens due to retrogradation (beta conversion) of the starch. Therefore, the decorative body toy including the decorative body 60 can have increased stability and durability.

The creamy product 10 according to the present embodiment may be used for decoration in combination with a semi-transparent creamy product or an opaque creamy product.

The embodiment of the present disclosure described above allows for providing a creamy product according to the following aspects.

A creamy product according to a first aspect is a creamy product to be discharged using a piping tool to prepare a decorative body toy, the creamy product including: a transparent resin containing starch; and one or both of a glitter and a decorative chip body.

This aspect allows for visually recognizing the glitter or the decorative chip body that is contained in the creamy product, and the object to be decorated can also be seen through. Thus, as compared with the opaque or semi-transparent creamy product, a visual effect of visually recognizing the decorative body or the object to be decorated that is mixed in the creamy product is achieved. The user can freely enjoy putting such a creamy product by discharging the creamy product, and this allows for providing a creamy product having a high visual effect for decorating the toy.

In the creamy product according to a second aspect, the decorative chip body is smaller than an opening diameter of a nozzle of the piping tool and larger than the glitter.

According to this aspect, the decorative chip body can be easily discharged from the nozzle according to the flow of the creamy product. The decorative body larger than the glitter achieves incorporating decorative bodies (including glitters) of various sizes into the creamy product to form a creamy product having a high visual effect.

The creamy product according to a third aspect includes the decorative chip body, in which the decorative chip body has a flat three-dimensional shape having one or both of a curved surface and a flat surface and has a convex portion on a side peripheral surface.

In this aspect, the decorative chip body having the convex portion, and the recess is well blended with the resin material of the creamy product and is less likely to settle, and thus, this makes the decorative chip body uniform within the creamy product. The decorative chip body having a flat shape achieves the small and occupied volume in the creamy product and ensuring the visibility of the viewer for the flat surface portion of the decorative chip body. Therefore, this suppresses a decrease in the fluidity of the creamy product.

The creamy product according to a fourth aspect, the decorative chip body has a recess on the side peripheral surface.

In this aspect, the recess formed on the side peripheral surface of the decorative chip body increases the contact area of the decorative chip body with the resin having the fluidity, and this allows to reduce the loss of the uniformity in the mixing due to the decorative chip body sinking in the container or the like or the decorative chip body sinking in the decorative body 60 during drying.

A piping tool according to a fifth aspect includes: a creamy product configured to prepare a decorative body toy including a transparent resin containing starch, and one or both of a glitter and a decorative chip body; a container having translucency and flexibility for containing the creamy product; and a nozzle that is connected to one end of the container, in which the container is sealed on an opposite side to the nozzle and contains the creamy product.

This aspect allows to visually recognize the glitter or the decorative chip body that is contained in the creamy product, and the object to be decorated can also be seen through. Therefore, as compared with the opaque or semi-transparent creamy product, a visual effect of visually recognizing the decorative body or the object to be decorated that is mixed in the creamy product is achieved. The user can freely enjoy putting such a creamy product by discharging the creamy product in the same way as squeezing out the whipped cream using the piping tool, and this allows for providing a piping tool for a creamy product having a high visual effect for decorating the toy.

A method for producing a creamy product according to a sixth aspect is a method for producing a creamy product to be discharged using a piping tool to prepare a decorative body toy, in which the piping tool includes a container having translucency and flexibility for containing the creamy product, and a nozzle that is connected to one end of the container, the method including: supplying, to the container, one or both of a glitter and a decorative chip body; and supplying a transparent resin containing starch to the container to which one or both of the glitter and the decorative chip body are supplied.

In this aspect, in the container, the step of supplying one or both of the glitter and the decorative chip body is performed first, and the step of supplying the transparent resin containing starch is subsequently performed. Thus, this achieves suppressing unintentional scratch and/or break of the glitter and decorative chip body in the resin stirring device (the mixing device) or the like and achieves uniforming the number of glitters or decorative chip bodies contained in one container. That is, a possibility of occurrence of uneven mixing in the resin stirring device (the mixing device) or the like can be reduced, the intended number of glitters and decorative chip bodies can be contained in the creamy product, and the unevenness in the product quality can be suppressed. Therefore, a method for producing a creamy product having a high visual effect of decorating a toy is provided.

The embodiment of the present disclosure has been described above. The aspects of the present disclosure are not limited to this embodiment. For example, the creamy product may include two or more types of decorative chip bodies or only one type of decorative chip body. When the creamy product includes two or more types of decorative chip bodies, the number of types may be extremely large or small. In this way, the user can also enjoy playing a lottery game of winning or losing among the randomly discharged decorative chip body.

The decorative chip body 40 is not limited to the configuration described in the present embodiment and may have another configuration.

What is claimed is:

1. A creamy product to be discharged using a piping tool to prepare a decorative body toy, the creamy product comprising:
a transparent resin comprising starch; and
one or both of a glitter and a decorative chip body.

2. The creamy product according to claim 1,
wherein the decorative chip body is smaller than an opening diameter of a nozzle of the piping tool and larger than the glitter.

3. The creamy product according to claim 2, further comprising:
the decorative chip body,
wherein the decorative chip body has a flat three-dimensional shape having one or both of a curved surface and a flat surface and has a convex portion on a side peripheral surface.

4. The creamy product according to claim 3,
wherein the decorative chip body has a recess on the side peripheral surface.

5. A piping tool comprising:
a creamy product for preparing a decorative body toy, comprising a transparent resin comprising starch, and one or both of a glitter and a decorative chip body;
a container having translucency and flexibility for containing the creamy product; and
a nozzle connected to one end of the container,
wherein the container is sealed on an opposite side to the nozzle and contains the creamy product.

6. A method for producing a creamy product to be discharged using a piping tool to prepare a decorative body toy, the method comprising:
supplying, to the container, one or both of a glitter and a decorative chip body; and
supplying a transparent resin containing starch to the container to which one or both of the glitter and the decorative chip body are supplied,
wherein the piping tool includes a container having translucency and flexibility for containing the creamy product, and a nozzle connected to one end of the container.
